(19) United States
(12) Patent Application Publication
(10) Pub. No.: US 2016/0237740 A1
(43) Pub. Date: Aug. 18, 2016

(54) LADDER TAPE AND METHOD OF MAKING THE SAME

(71) Applicant: NIEN MADE ENTERPRISE CO., LTD., Taichung City (TW)

(72) Inventor: Yung-Chieh HUANG, CHANGHUA COUNTY (TW)

(21) Appl. No.: 15/043,889

(22) Filed: Feb. 15, 2016

(30) Foreign Application Priority Data
Feb. 16, 2015 (CN) 201510084098.8

(51) Int. Cl. E06B 9/307; D04B 21/14

(52) U.S. Cl. CPC E06B 9/307; D04B 21/14

(57) ABSTRACT

A ladder tape and a method of making the ladder tape are disclosed in the present invention, wherein, by using a knitting technique, at least two warps and at least one weft generate a knitting structure with chains on a front surface of a first band and a second band, which have the same width, and generate threading segments on a rear surface of each of the bands to bind the weft. Whereby, the resultant knitting structure has no discontinuous opaque shades, and the problem of unwanted light leakage can be avoided as well.

The current application claims a foreign priority to application number 201510084098.8 filed on Feb. 16, 2015 in China.

### BACKGROUND OF THE INVENTION

1. Technical Field

The present invention generally relates to knitted fabrics, and more particularly to a ladder tape and a method of making the ladder tape.

2. Description of Related Art

Ribbon style ladder tapes are widely used in window blinds to support slats. However, ladder tapes made by different knitting techniques usually have different disadvantages which need to be overcome. For example, while making a commonly seen ribbon style ladder tape, it needs to manually cut redundant connecting threads after completing the knitting, which leads to a time-consuming manufacturing process and a low yield. Also, as illustrated in FIG. 1, the front appearance of such ladder tape 1 has several discontinuous, annoying shades when exposed to light, for the portions corresponding to the threads of wefts which support slats have higher stitch density than other portions on the ribbon.

A China patent, of which patent number 201121234, has disclosed an improved structure for ribbon style ladder tapes, where two ends of a weaving thread are integrally connected to the front crochet ribbon and the rear crochet ribbon through a crocheting process. In this way, it is not necessary to cut any weaving threads between the front crochet ribbon and the rear crochet ribbon; therefore, the inherent problem of needing additional manpower to manually cut redundant connecting threads while making a conventional ladder tape is solved. Furthermore, the technique disclosed in said patent also avoids the unwanted opaque shades formed at where threads of wefts are connected to the ribbons.

However, though the problems above are solved, said patent seems to create another disadvantage. Knitting pattern 3 shown in FIG. 2 is so loose that a lot of holes 3a are left therebetween. As a result, while using such a ladder tape with a window blind, light may leak in through those holes 3a. Therefore, the conventional method of making a ladder tape and the conventional structure of a ladder tape both still have room for improvement.

### BRIEF SUMMARY OF THE INVENTION

In view of the reasons mentioned above, the primary objective of the present invention is to provide a ladder tape and a method of making the ladder tape, which have no redundant connecting threads needed to be manually cut. Therefore, the time required to make a ladder tape can be shortened, and the yield can be increased as well. Also, the ladder tape provided in the present invention does not have the problem of light leakage, and the resultant knitting structure of the provided method is well-proportioned.

The present invention provides a ladder tape, which includes a first band, a second band, a first warp, a second warp, and at least one weft. The first band and the second band respectively have a front surface and a rear surface. The first warp and the second warp respectively interlaces the front surface and the rear surface along a long axis of the corresponding band, wherein each of the warps forms a plurality of threading segments on the rear surface; a slit is left between each of the threading segments and the rear surface. The weft shuttles between the first warp and a second warp, wherein the weft comprises a plurality of first portions following a S-shaped path to pass through the slits left between the threading segment of the first warp and the rear surface of the first band, a plurality of second portions following a S-shaped path to pass through the slits left between the threading segment of the second warp and the rear surface of the second band, and a plurality of bridging portions, each of which is connected to the corresponding first portion and the corresponding second portion with two ends thereof respectively.

In an embodiment, each of the warps forms a plurality of loop-shaped visible segments on the front surface of the corresponding band; the visible segments interlock one another.

The present invention further provides a method of making a ladder tape, which includes the following steps: a) provide a first band and a second band in parallel, wherein each of the bands has a front surface and a rear surface; the first band and the second band are adapted to be pulled downward in a vertical direction; b) control a hook portion of a first crochet needle to move forward and backwards to pass through the first band, and control a hook portion of a second crochet needle to move forward and backwards to pass through the second band; c) place a first warp on the hook portion of the first crochet needle to pull the first warp from the rear surface of the first band to the front surface thereof, wherein the first warp forms a first chain on the front surface of the first band, and forms a plurality of threading segments on the rear surface of the first band; and place a second warp on the hook portion of the second crochet needle to pull the second warp from the rear surface of the second band to the front surface thereof, wherein the second warp forms a second chain on the front surface of the second band, and forms a plurality of threading segments on the rear surface of the second band; and d) move a weft vertically along a S-shaped path to pass through a series of the threading segments of the first warp, pull the weft across a space between the first band and the second band, moving the weft vertically along a S-shaped path to pass through a series of the threading segments of the second warp, and pull the weft back to the first warp to continuously pass through another series of the threading segments of the first warp after going through a predetermined distance on the second band; wherein the weft is repeatedly pulled and moved in such manner between the first warp and the second warp until a knitting is completed.

In an embodiment, the first crochet needle and the second crochet needle are synchronously moved forward or backwards.

In an embodiment, after the first crochet needle and the second crochet needle are moved forward to pass through the corresponding band and before arriving at a first predetermined point, the weft goes beneath the first crochet needle and the second crochet needle; when the first crochet needle and the second crochet needle are continuously moved forward to arrive at a second predetermined point, and then are moved backwards, the first warp is placed on the hook portion of the first crochet needle, and the second warp is placed on the hook portion of the second crochet needle; after that, the first crochet needle and the second crochet needle respectively pull the corresponding warps backwards to leave the corresponding bands.

In an embodiment, the first warp passes through a first warp knitting needle, while the second warp passes through a second warp knitting needle; the first warp knitting needle and the second warp knitting needle are rotationally moved along a surrounding path on a virtual vertical plane to place the first warp on the hook portion of the first crochet needle, and to place the second warp on the hook portion of the second crochet needle.

In an embodiment, a guiding tube which is movable back and forth in a lateral direction is provided to feed the weft; when the first crochet needle and the second crochet needle are moved from the first predetermined point to the second predetermined point, the guiding tube is moved upward to a position higher than the first crochet needle and the second crochet needle; when the first crochet needle and the second crochet needle respectively pull the corresponding warps backwards to leave the corresponding bands, the guiding tube is laterally moved in one of two opposite directions to continuously feed the weft.

With the invention above, the manufacturing process can be simplified, and labor cost can be reduced. Also, the resultant ladder tape is beautiful and has no those opaque shades; the problem of light leakage can be avoided at the same time.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a plan view of a conventional ribbon style ladder tape;

FIG. 2 is a perspective view of another conventional ribbon style ladder tape;

FIG. 3 is a perspective view of a window blind, showing the window blind includes the ladder tape of a preferred embodiment of the present invention;

FIG. 4 is an enlarged partial view of FIG. 3;

FIG. 5 is a partial front view of the first band of the ladder tape of the preferred embodiment of the present invention;

FIG. 6 is a partial rear view of the first band of the ladder tape of the preferred embodiment of the present invention;

FIG. 7 is a segmental view along the 7-7 line in FIG. 6;

FIG. 8 is similar to FIG. 4, showing the knitting path of a weft;

FIG. 9 is similar to FIG. 8, showing the knitting path of another weft;

FIG. 10 is a perspective view of the knitting apparatus adapted to implement the method of making the ladder tape of the present invention;

FIG. 11 is a simplified schematic view, showing the moving path of the warp knitting needle and the guiding tube of the knitting apparatus shown in FIG. 10;

FIG. 12 is a plan view of FIG. 11;

FIG. 13 is a perspective view, showing the positions of the warps and the weft while being knitted;

FIG. 14 is a front view, showing the first crochet needle of the knitting apparatus is moved forward;

FIG. 15 is a perspective view, showing first warp runs over the first crochet needle;

FIG. 16 is similar to FIG. 15, showing the first warp knitting needle is controlled to swing downward, and the first crochet needle is moved backwards;

FIG. 17 is similar to FIG. 14, showing first crochet needle is moved backwards with its hook portion hooks the first warp; and

FIG. 18 is similar to FIG. 15, showing first crochet needle is moved backwards to leave the first band.

### DETAILED DESCRIPTION OF THE INVENTION

We are going to describe the structure of the ladder tape provided in the present invention first, and explain the method of making it afterwards.

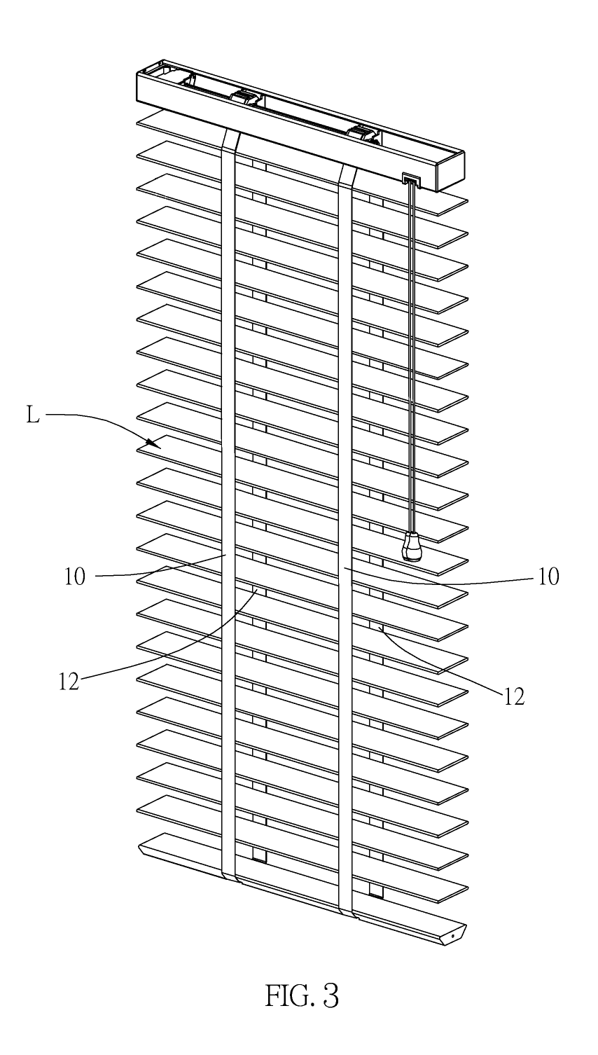

A ladder tape 100 of a preferred embodiment of the present invention is illustrated in FIG. 3 to FIG. 7, which is adapted to be used with a window blind, and includes a first band 10, a second band 12, a first warp 14, a second warp 16, and two wefts 18, 19. It has to mention that, the number of the components above including the first warp 14, the second warp 16, and the wefts 18, 19 can be further increased to meet different practical requirements.

The first band 10 and the second band 12 are elongated woven bands, which are tightly woven and, therefore, opaque. The width and texture of the first band 10 and the second band 12 are not limited in the present invention, which can be decided by the manufacturers to meet different requirements. The first band 10 has a front surface 10a and a rear surface 10b. Similarly, the second band 12 also has a front surface 12a and a rear surface 12b. The front surfaces mentioned herein refer to the surfaces which can be directly seen when the ladder tape 100 is in use; the rear surfaces mentioned herein refer to the surfaces of the first band 10 and the second band 12 which face each other.

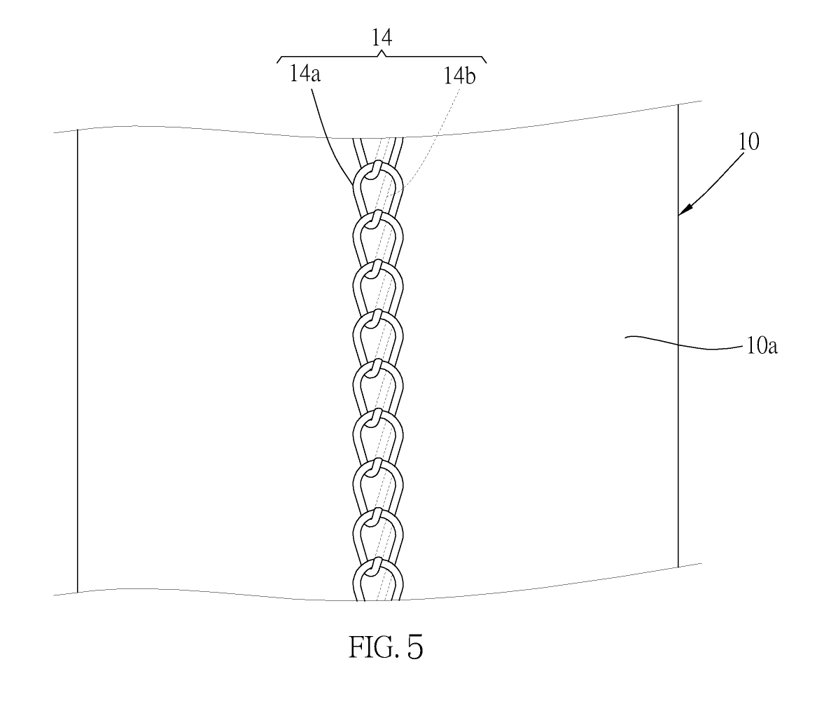

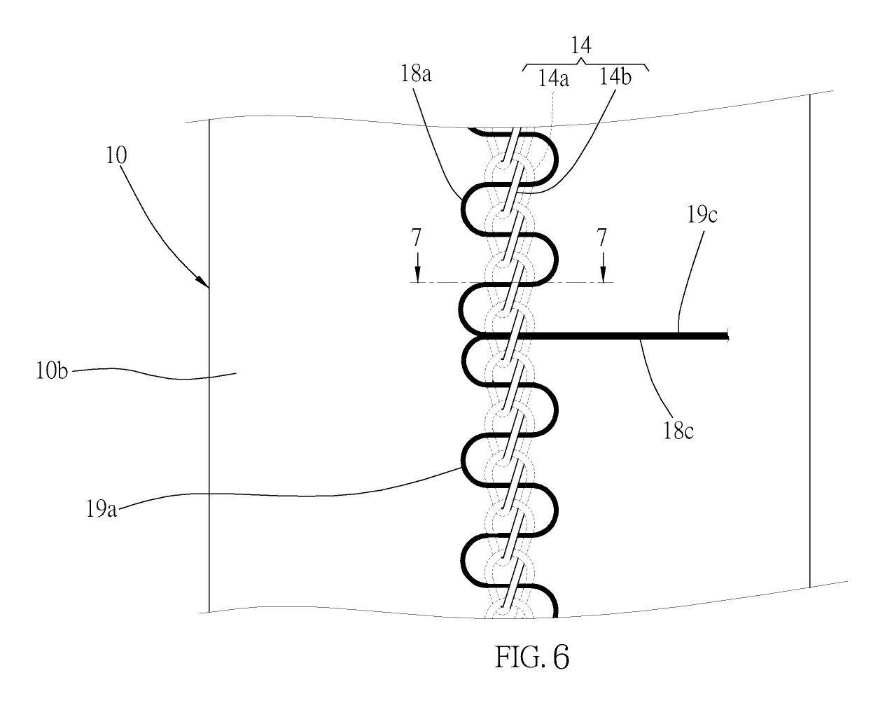

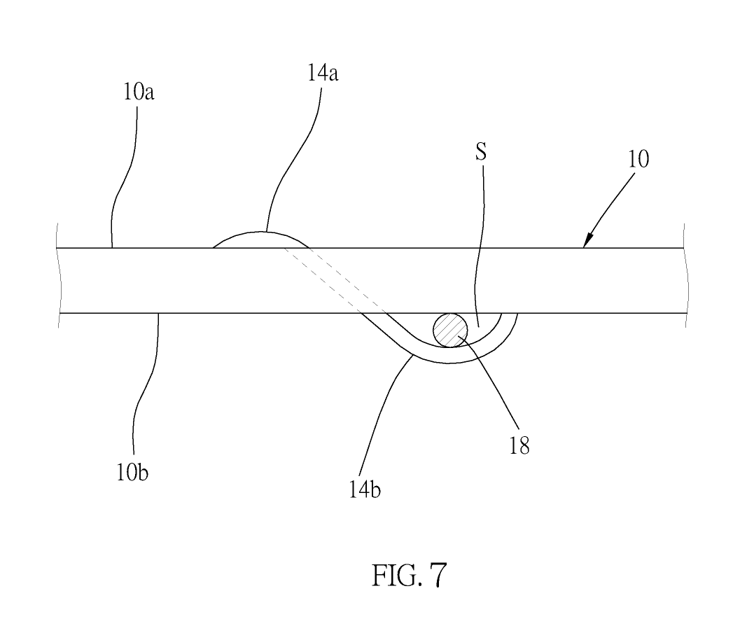

The first warp 14 and the second warp 16 are made by the same knitting method, and are respectively stitched onto the first band 10 and the second band 12. In the following paragraphs, we'll use the first warp 14 and the first band 10 to explain the concept of the present invention. The first warp 14a follows a regular stitching path to interlace the front surface 10a and the rear surface 10b along a long axis of the first band 10. As shown in FIG. 5, visible segments 14a of the first warp 14 on the front surface 10a are loop-shaped, wherein the visible segments 14a interlock one another, which are called a first chain hereafter. As shown in FIG. 6 and FIG. 7, the first warp 14 forms a plurality of threading segments 14b on the rear surface 10b, wherein each of the threading segments 14b aligns with the same oblique direction, and a slit S is left between each of the threading segment 14b and the rear surface 10b. Similarly, the second warp 16 also has visible segments on the front surface 12a of the second band 12, and has threading segments and slits on the rear surface 12b of the second band 12. However, the visible segments, the threading segments, and slits of the second warp 16 are not shown in the figures. By following the same naming rule, the visible segments of the second warp 16 are called a second chain hereafter.

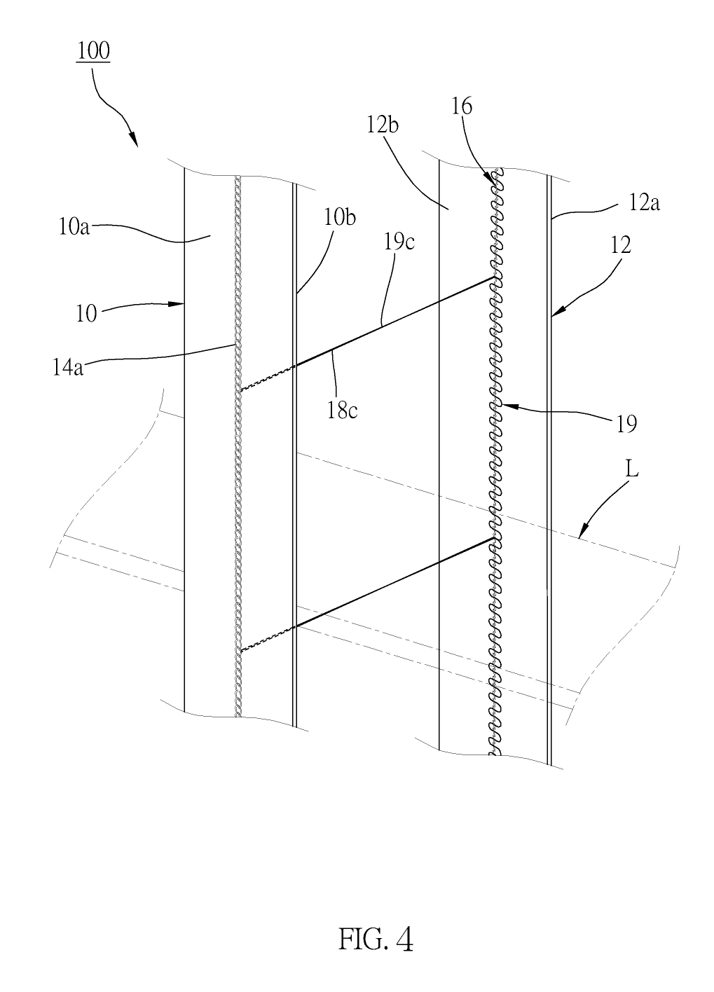

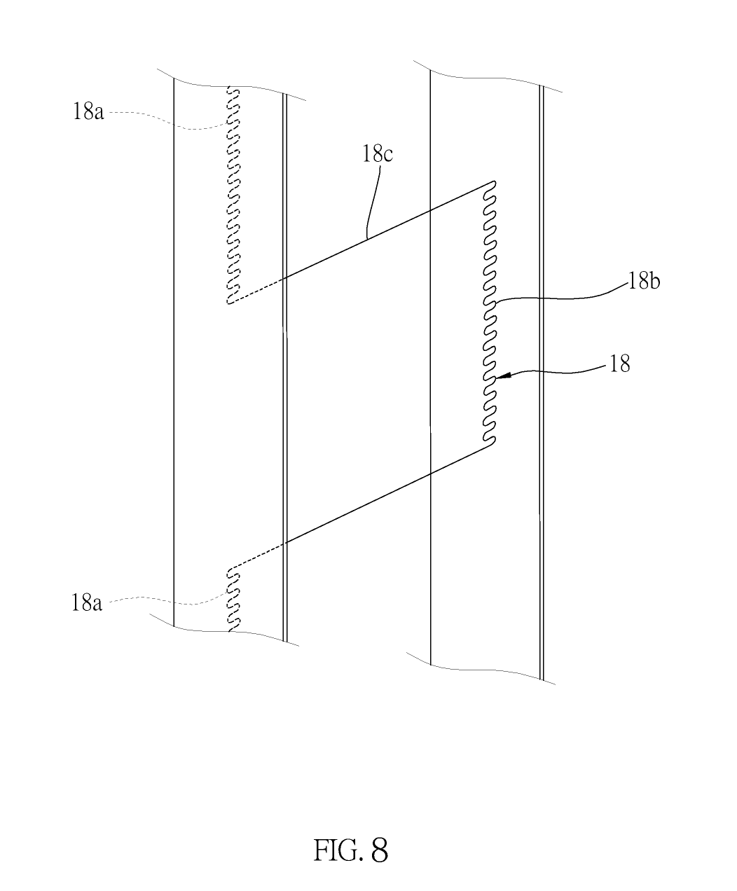

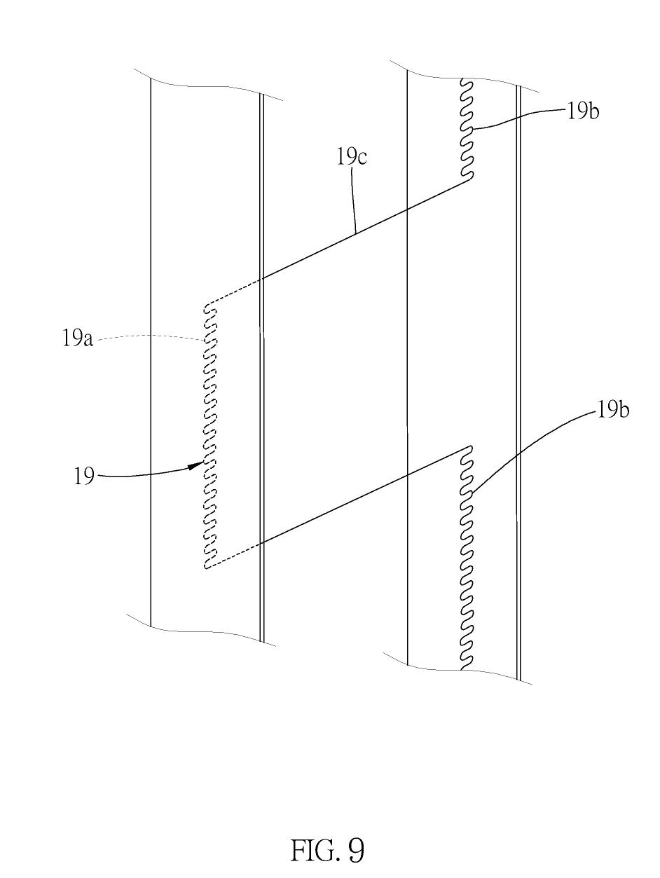

While stitching the first warp 14 and the second warp 16, the wefts 18, 19 shuttle between the first warp 14 and the second warp 16 through a knitting technique. As shown in FIGS. 4, 6, and 8, the weft 18 follows an S-shaped path along the long axis of the first band 10 to passes through a series of slits S of the threading segments 14b of the first warp 14 on the rear surface 10b. After being moved for a predetermined distance on the first band 10, the weft 18 is pulled across the space between the first band 10 and the second band 12, and then the weft 18 continues passes through a series of slits S of the threading segments of the second warp 16 on of the rear surface 12b. Similarly, after being moved for another predetermined distance on the second band 12, the weft 18 is pulled back to the first warp 14, and so on. The process continues until the knitting is completed. As for the weft 19 (shown in FIG. 9), similarly, it follows a S-shaped path to shuttle through the second warp 16 along a long axis of the second band 12 first, gets across the space between the second band 12 and the first band 10 to shuttle through the first warp 14, gets back to the second warp 16 again, and so on and on.

In the description above, the segments of the wefts 18, 19 winding around the first warp 14 are respectively defined as first portions 18a (19a), and the segments winding around the second warp 16 are respectively defined as second portions 18b (19b). The cross-over segments of the wefts 18, 19 between the first warp 14 and the second warp 16 are defined as bridging portions 18c (19c). In other words, two ends of each of the bridging portion 18c (19c) are respectively connected to a corresponding first portion 18a (19a) and a corresponding second portion 18b (19b). Each of the bridging portions 18c (19c) is used to support one single slat L of a window blind.

It has to be mentioned that, since the wefts 18, 19 of the ladder tape 100 pass through the slits S left between the threading segments 14b of the first warp 14 and the rear surface 10b (or between the threading segments of the second warp 16 and the rear surface 12b), the wefts 18, 19 are bound by these threading segments to be firmly fixed onto the rear surface 10b (or the rear surface 12b) of each of the bands 10, 12. In other words, the wefts 18, 19 in the preferred embodiment are hidden behind each of the bands 10, 12 and cannot be seen directly.

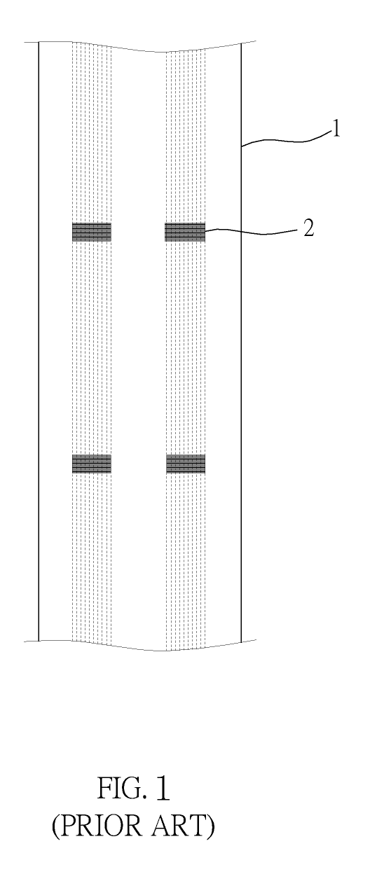

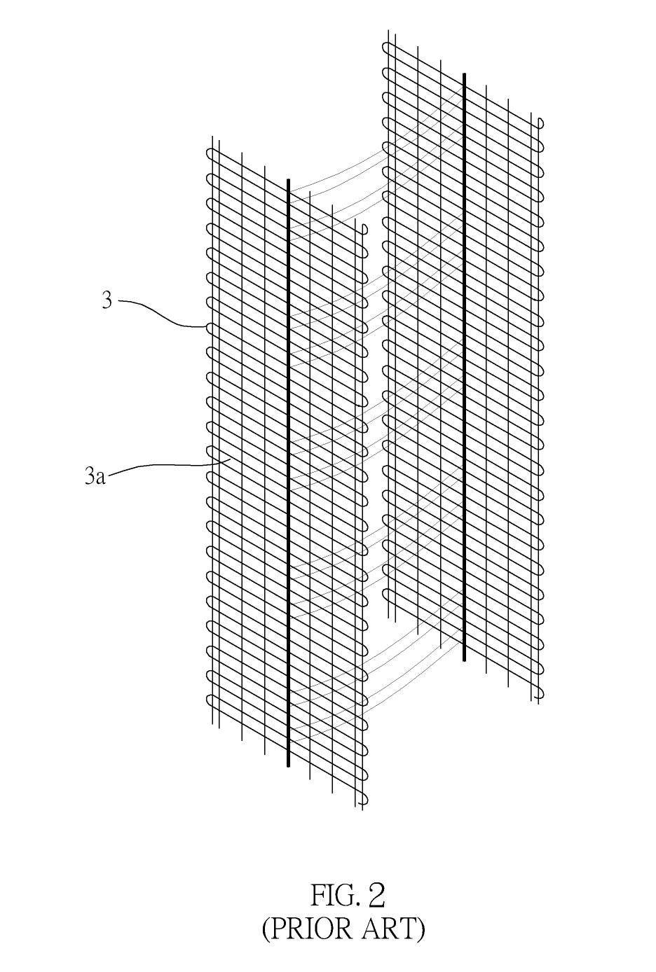

The first band 10 and the second band 12 of the ladder tape 100 in the preferred embodiment are tightly woven and opaque; the first warp 14 and the second warp 16 are stitched onto the corresponding bands 10, 12 by a knitting technique. In addition that the threading segments the first warp 14 and the second warp 16 can tightly bind the wefts 18, 19, when exposed to light, the front surfaces 10a, 12a won't have any discontinuous opaque shade, for the bands 10, 12 have consistent stitch density everywhere thereon, even for the portions where the weft 18 (19) passes through the threading segments. More specifically, instead of the discontinuous opaque shades seen on a conventional ladder tape as shown in FIG. 1, the front surfaces 10a, 12a of the bands 10, 12 of the preferred embodiment only have the first chain and the second chain shown thereon. Also, since the first warp 14, the second warp 16, and the wefts 18, 19 are stitched onto the first band 10 and the second band 12 by a knitting technique, the first band 10 and the second band 12 would not be deformed or have small holes formed thereon due to the effect of gravity when the bridging portions 18c, 19c are used to supporting the slats L. As a result, the effect of blocking light for the slats L would be better.

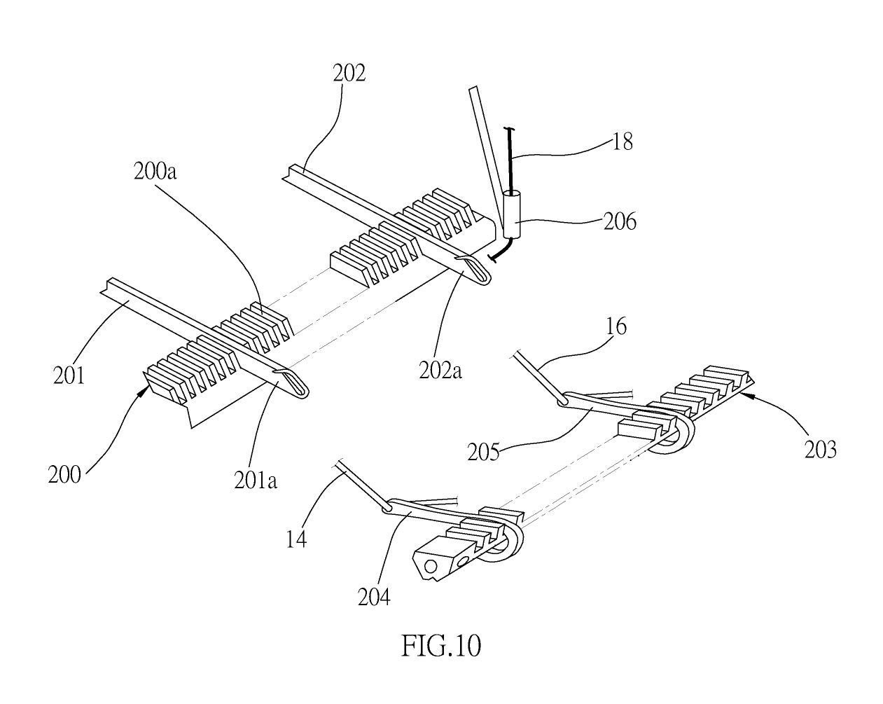

The method of making the ladder tape 100 is explained in the following paragraphs. As shown in FIG. 10, a knitting apparatus suitable to use the method includes a needle holder 200, a first crochet needle 201, a second crochet needle 202, a needle seat 203, a first warp knitting needle 204, a second warp knitting needle 205, and a guiding tube 206. The selected knitting materials include the first band 10, the second band 12, the first warp 14, the second warp 16, and the wefts 18, 19. We are going to introduce the function and action of the components of the knitting apparatus first, and then explain the method of making the ladder tape afterwards.

The needle holder 200 is located on the front surface of each of the bands, and is fixed to its location, wherein a plurality of needle channels 200a are provided thereon to let the crochet needle movably received therein. In the preferred embodiment, the first warp 14 and the second warp 16 are knitted synchronously when the first crochet needle 201 and the second crochet needle 202 are placed in the needle channels 200a of the needle holder 200. The first crochet needle 201 and the second crochet needle 202 are controllable to synchronously move forward or backwards in the direction of a Z axis, wherein, when the first crochet needle 201 and the second crochet needle 202 are moved forward, hook portions 201a, 202a at a front thereof pass through the bands to the rear surfaces; when the first crochet needle 201 and the second crochet needle 202 are moved backwards, the hook portions 201a, 202a at the front thereof leave the bands and are at the front surfaces.

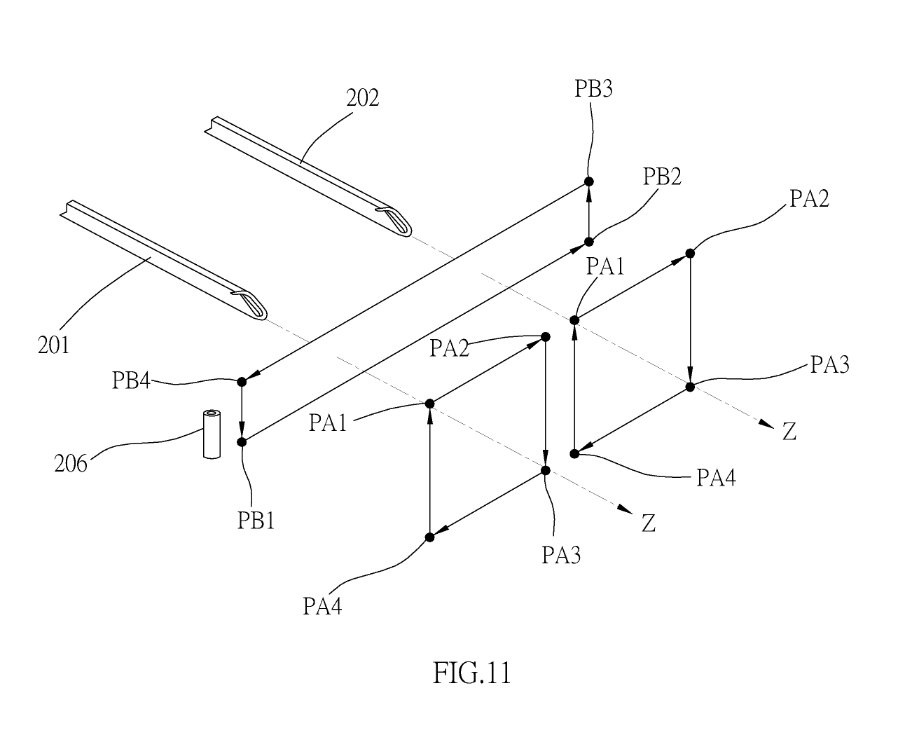

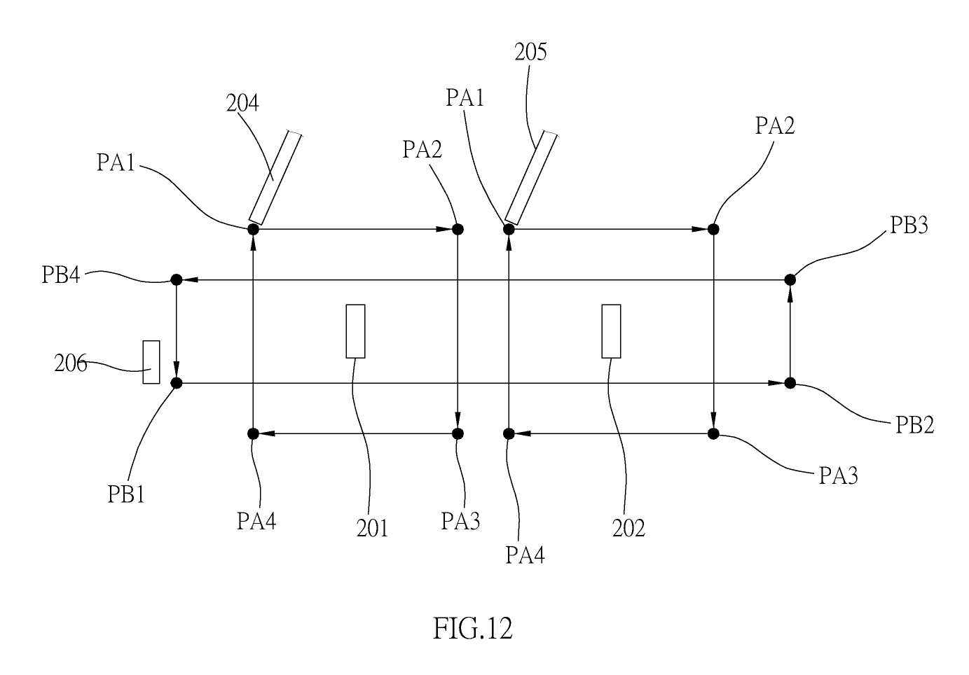

The first warp knitting needle 204 and the second warp knitting needle 205a are both provided on the needle seat 203, and are both located on the rear surface of each of the bands. The first warp 14 passes through a front end of the first warp knitting needle 204, while the second warp 16 passes through a front end of the second warp knitting needle 205. Because the needle seat 203 can be moved back and forth in the direction of an X axis and swing, the front ends of the first warp knitting needle 204 and the second warp knitting needle 205 can be rotationally moved in a clockwise manner along a surrounding path from a position PA1, a position PA2, a position PA3, to a position PA4 which are on a virtual vertical plane as illustrated in FIG. 11 and FIG. 12, and each of the crochet needles 201, 202 passes through one of the pieces of space surrounded by the positions PA1-PA4.

One of the wefts 18, 19 passes through the guiding tube 206, which can be moved back and forth in the direction of the X axis (i.e., laterally) to feed the weft. In the preferred embodiment, the guiding tube 206 is controllable to rotationally move in a counter-clockwise manner from a position PB1, a position PB2, a position PB3, to a position PB4 which are on a virtual vertical plane, wherein the first crochet needle 201 and the second crochet needle 202 can pass through the space surrounded by the positions PB1-PB4. More specifically, the virtual vertical plane having the positions PA1-PA4 and the virtual vertical plane having the positions PB1-PB4 are arranged one after the other in the direction of the Z axis.

Before we start explaining the method of making the ladder tape with the aforementioned knitting apparatus, it has to be mentioned that, since the first warp 14, the second warp 16, and the wefts 18, 19 are knitted synchronously, and the first warp 14 and the second warp 16 are knitted in the same way, we'll take the first warp 14 and one of the wefts 18 as an example for explanation.

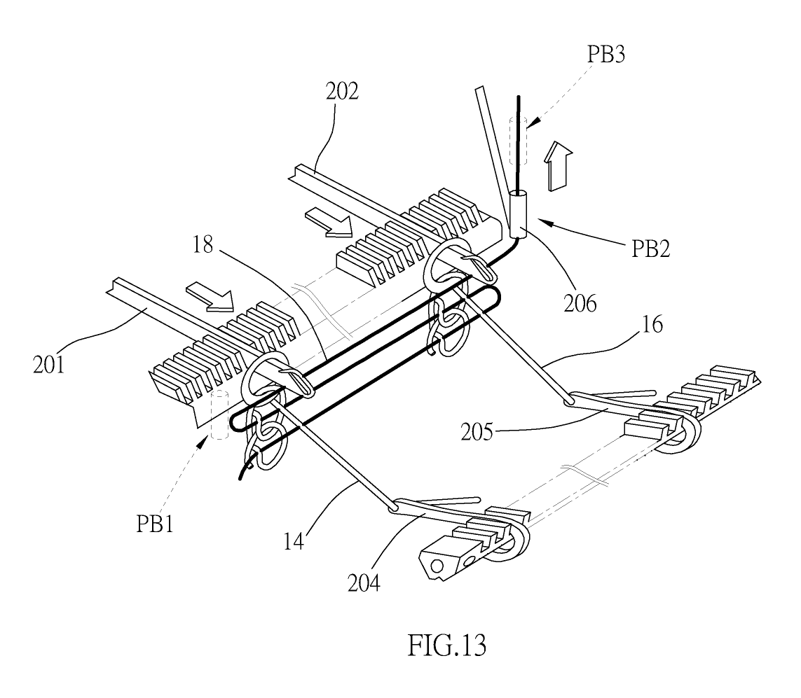

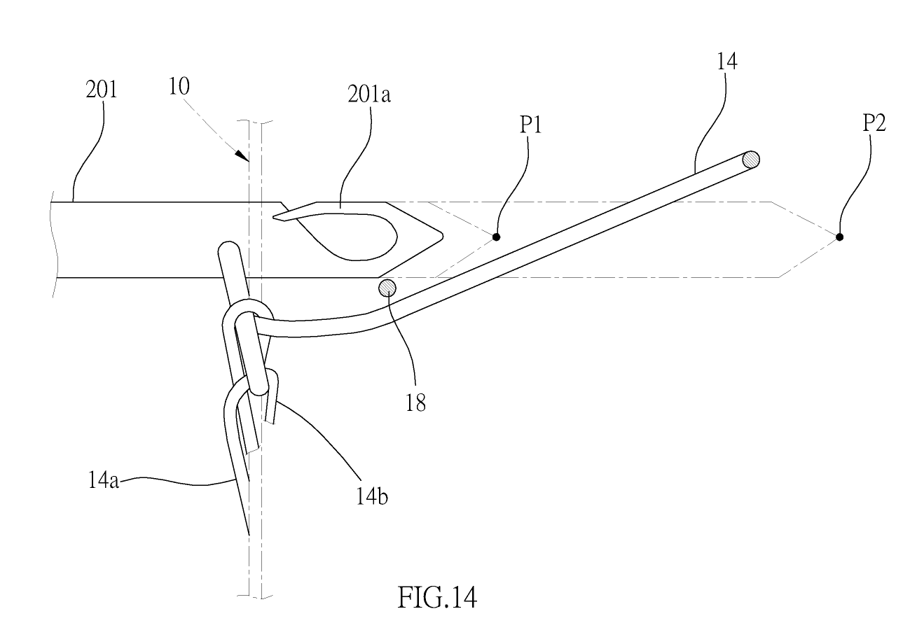

As shown in FIG. 13 to FIG. 15, the first band 10 is placed between the needle holder 200 and the needle seat 203, and can be pulled and rolled in the direction of a Y axis (i.e., vertically). The first crochet needle 201 is controllable to move forward along the Z axis. After the hook portion 201a thereof passing through the band and before arriving a first predetermined point P1 (see FIG. 14), the guiding tube 206 has been moved from the position PB1 to the position PB2; when the first crochet needle 201 arrives at the first predetermined point P1, the weft 18 fed by the guiding tube 206 is just under the first crochet needle 201. By moving the guiding tube 206 from the position PB1 to the position PB2, the weft 18 is pulled from the first warp 14 to the second warp 16.

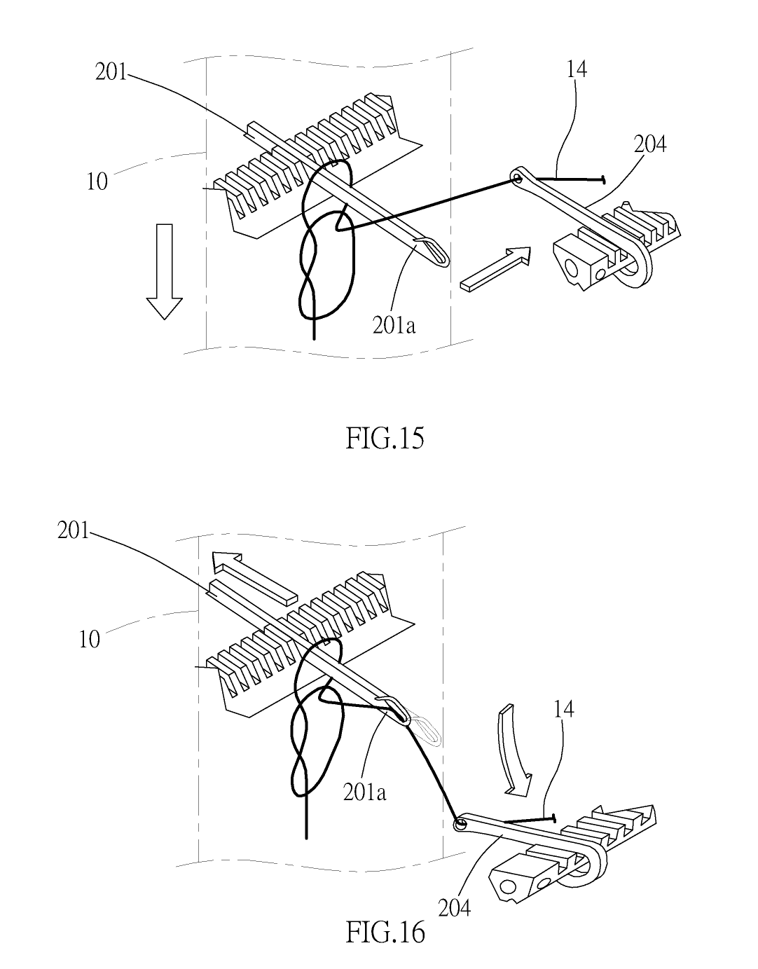

After that, when the first crochet needle 201 is continuously moved toward a second predetermined point P2, the guiding tube 206 is moved upward to the position PB3, which is higher than the first crochet needle 201. At this time, the location of the weft 18 remains unchanged due to being pressed by the first crochet needle 201. On the other hand, the first warp knitting needle 204 is moved from the position PA1 to the position PA2 when the first crochet needle 201 arrives at the second predetermined point P2. This action makes the first warp 14 cross over the first crochet needle 201, as shown in FIG. 15. At certain determined moment, the guiding tube 206 located at the position PB3 is moved toward the position PB4, whereby the weft 18 is pulled from the second warp 16 back to the first warp 14. Furthermore, the segments of the weft 18 which shuttle between the first warp 14 and the second warp 16 become the bridging portions 18c which are adapted to support slats as illustrated in FIG. 4.

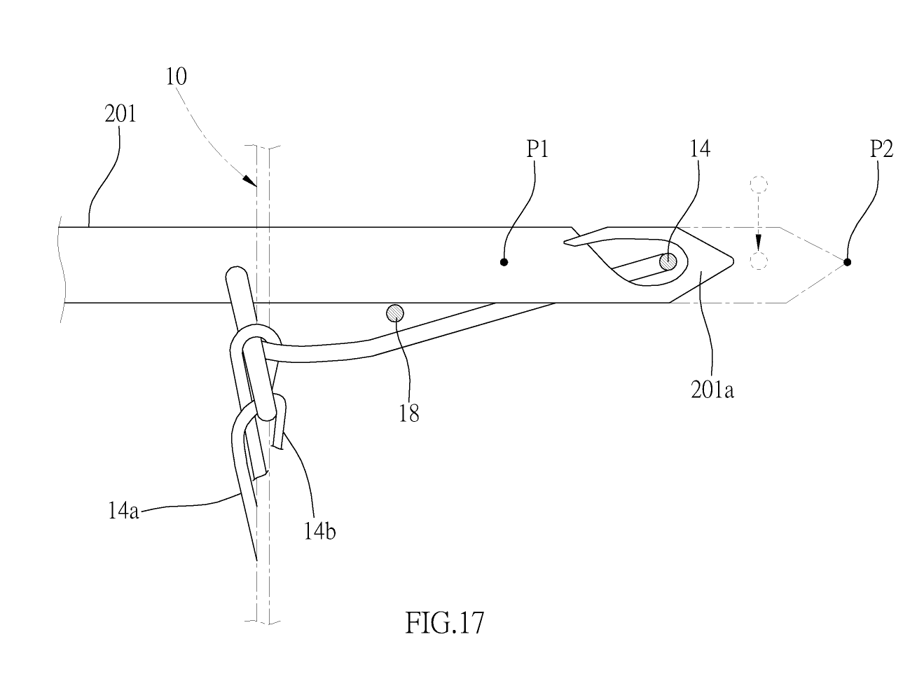

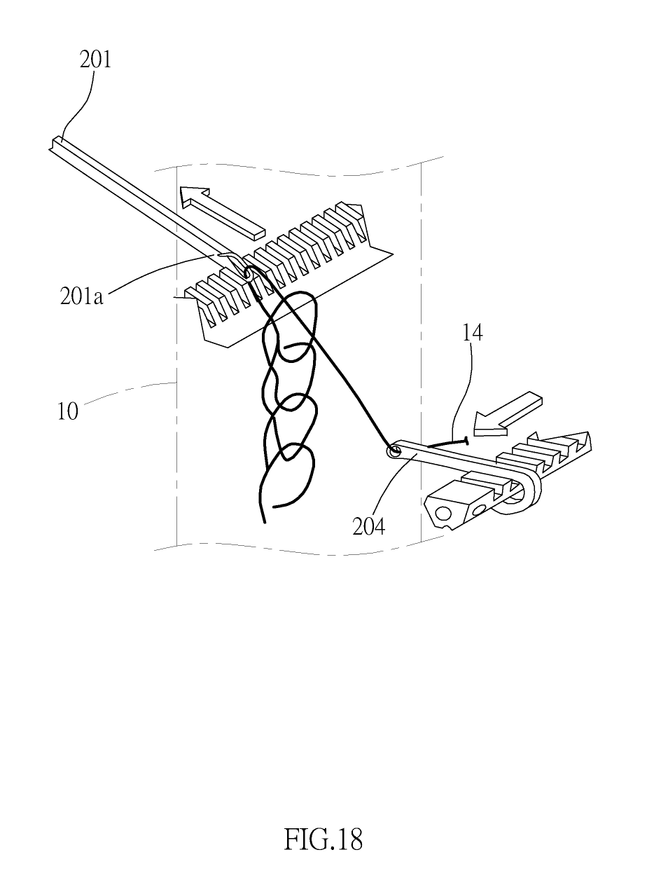

As shown in FIG. 16 and FIG. 17, when the first crochet needle 201 is controlled to move backwards, the first warp knitting needle 204 is controlled to swing downward. In other words, the front end thereof is moved from the position PA2 toward the position PA3, whereby the first warp 14 can be hooked by the hook portion 201a. When the first crochet needle 201 is continuously moved backwards to leave the first band 10, the first warp 14 is pulled from the rear surface 10b of the first band 10 to the front surface 10a thereof (see FIG. 18). By repeating the aforementioned knitting actions, and by pulling and rolling the band, the first warp 14 finally forms the first chain (see FIG. 5) which is composed of the multiple loop-shaped visible segments 14a on the front surface 10a of the first band 10, and forms the plurality of threading segments 14b (see FIG. 6) on the rear surface 10b of the first band 10. At the same time, the weft 18 is pressed by the threading segments 14b of the first warp 14 and bound on the rear surface 10b (see FIG. 7). Similarly, the second warp 16 forms the same knitting structure on the front surface and the rear surface of the second band 12 by the same knitting actions, and we are not going to repeat the same description in details herein.

And then, after the first crochet needle 201 is moved back into the needle holder 200 (i.e., casting off the needle), the guiding tube 206 will be moved from the position PB4 back to the position PB1 to wait for another feeding of the weft. At the same time, the first warp knitting needle 204 will be also moved toward the position PA4, so that when the crochet needle is moved forward again, the first warp knitting needle 204 can be properly moved from the position PA1 toward the position PA2.

In summary, the ladder tape 100 provided in the present invention has no discontinuous opaque shades, and the problem of light leakage can be avoided as well. Also, the method provided in the present invention can make well-proportioned and beautiful products.

It must be pointed out that the embodiments described above are only some preferred embodiments of the present invention. All equivalent structures and methods which employ the concepts disclosed in this specification and the appended claims should fall within the scope of the present invention.

What is claimed is:

1. A ladder tape, comprising:
a first band and a second band, each of which has a front surface and a rear surface;
a first warp and a second warp, each of which interlaces the front surface and the rear surface along a long axis of the corresponding band, wherein each of the warps forms a plurality of threading segments on the rear surface; a slit is left between each of the threading segments and the rear surface; and
a weft shuttling between the first warp and a second warp, wherein the weft comprises a plurality of first portions following a S-shaped path to pass through the slits left between the threading segment of the first warp and the rear surface of the first band, a plurality of second portions following a S-shaped path to pass through the slits left between the threading segment of the second warp and the rear surface of the second band, and a plurality of bridging portions, each of which is connected to the corresponding first portion and the corresponding second portion with two ends thereof respectively.

2. The ladder tape of claim 1, wherein each of the warps forms a plurality of loop-shaped visible segments on the front surface of the corresponding band; the visible segments interlock one another.

3. A method of making a ladder tape, comprising steps of:
providing a first band and a second band in parallel, wherein each of the bands has a front surface and a rear surface; the first band and the second band are adapted to be pulled in a vertical direction;
controlling a hook portion of a first crochet needle to move forward and backwards to pass through the first band, and controlling a hook portion of a second crochet needle to move forward and backwards to pass through the second band;
placing a first warp on the hook portion of the first crochet needle to pull the first warp from the rear surface of the first band to the front surface thereof, wherein the first warp forms a first chain on the front surface of the first band, and forms a plurality of threading segments on the rear surface of the first band; and placing a second warp on the hook portion of the second crochet needle to pull the second warp from the rear surface of the second band to the front surface thereof, wherein the second warp forms a second chain on the front surface of the second band, and forms a plurality of threading segments on the rear surface of the second band; and
moving a weft vertically along a S-shaped path to pass through a series of the threading segments of the first warp, pulling the weft across a space between the first band and the second band, moving the weft vertically along a S-shaped path to pass through a series of the threading segments of the second warp, and pulling the weft back to the first warp to continuously pass through another series of the threading segments of the first warp after being moved for a predetermined distance on the second band;
wherein the weft is repeatedly pulled and moved in such manner between the first warp and the second warp until a knitting is completed.

4. The method of claim 3, wherein the first crochet needle and the second crochet needle are synchronously moved forward or backwards.

5. The method of claim 3, wherein, after the first crochet needle and the second crochet needle are moved forward to pass through the corresponding band and before arriving at a first predetermined point, the weft goes beneath the first crochet needle and the second crochet needle; when the first crochet needle and the second crochet needle are continuously moved forward to a second predetermined point, and then are moved backwards, the first warp is placed on the hook portion of the first crochet needle, and the second warp is placed on the hook portion of the second crochet needle; after that, the first crochet needle and the second crochet needle respectively pull the corresponding warps backwards to leave the corresponding bands.

6. The method of claim 5, wherein the first warp passes through a first warp knitting needle, while the second warp passes through a second warp knitting needle; the first warp knitting needle and the second warp knitting needle are rotationally moved along a surrounding path on a virtual vertical plane to place the first warp on the hook portion of the first crochet needle, and to place the second warp on the hook portion of the second crochet needle.

7. The method of claim 5, wherein a guiding tube which is movable back and forth in a lateral direction is provided to feed the weft; when the first crochet needle and the second crochet needle are moved from the first predetermined point to the second predetermined point, the guiding tube is moved upward to a position higher than the first crochet needle and the second crochet needle; when the first crochet needle and the second crochet needle respectively pull the corresponding warps backwards to leave the corresponding bands, the guiding tube is laterally moved in one of two opposite directions to continuously feed the weft.
